(19) United States
(12) Patent Application Publication
(10) Pub. No.: US 2024/0401378 A1
(43) Pub. Date: Dec. 5, 2024

(54) LOCK MECHANISM

(71) Applicant: ZIPPSAFE AG, Glattbrugg (CH)

(72) Inventors: David Ballagi-Pordany, Glattbrugg (CH); Carlo-Emilio Loderer, Glattbrugg (CH); Dario Alessandro Fontana, Glattbrugg (CH)

(21) Appl. No.: 18/800,080

(22) Filed: Aug. 11, 2024

Related U.S. Application Data
(62) Division of application No. 17/274,453, filed on Mar. 9, 2021.

(30) Foreign Application Priority Data
Sep. 10, 2018 (GB) 1814648.0

(51) Int. Cl. E05B 69/00; A44B 19/30; E05B 47/00

(52) U.S. Cl. CPC E05B 69/006; A44B 19/301; E05B 2047/0017

(57) ABSTRACT

Aspects of embodiments pertain to a lock mechanism for at least one puller-equipped fastener, the lock mechanism comprising a frame having at least one slot, each of the at least one slot comprising an opening and a closed end; at least one actuator affixed to the frame; at least one arm operationally coupled to each actuator, and at least one rotating member operationally coupled to each actuator and to the at least one arm coupled thereto; wherein each arm obstructs one of the at least one slot adjacent to the opening when the actuator coupled thereto is in a first state, and unblocks the slot when the actuator coupled thereto is in a second state, and wherein each at least one rotating member is selectively switchable by the actuator coupled thereto between a first position when the actuator is in the first state and a second position when the actuator is in the second state, and wherein the lock mechanism is configured to allow each at least one rotating member in the first position to counterpoise force enacted on the at least one arm coupled thereto to unblock the slot, and in the second position to allow each at least one arm coupled thereto to unblock the slot.

### CROSS REFERENCE TO RELATED APPLICATIONS

This is a divisional application of U.S. patent application Ser. No. 17/274,453 filed Mar. 9, 2021 (now allowed), which was a 371 application from international patent application No. PCT/EP2019/074035, which claims priority to GB patent application No. 1814648.0 filed Sep. 10, 2018, the content of which is incorporated herein by reference in its entirety

### TECHNICAL FIELD AND BACKGROUND

The present disclosure relates to item storage devices for securely storing items; the devices include containers or receptacles and fasteners. The terminology “securely storing” as well as grammatical variations thereof may relate to a configuration in which access to the receptacle's storage area is, by design-intent, not intended to be enabled other than through unsecuring of the fastener and setting the fastener to open the receptacle without damaging or otherwise compromising the structural and/or functional integrity of the receptacle and/or the fastener.

The receptacle may define a storage area for receiving an item, e.g., a hanger by suspension. A fastener, e.g., a zipper, may operably cooperate with a lock mechanism for selectively securing the fastener in a closed position and for unsecuring the fastener for allowing the fastener to be set from the closed into an open position. In the open position, the receptacle's storage area can be accessed by a user of the device for removing an item and/or placing an item therein for storage.

The lock mechanism should have some resistance to attempts to force the lock.

### GENERAL DESCRIPTION

Aspects of some disclosed embodiments provide for securely storing items.

Some lock mechanism embodiments are provided that include a frame with at least one slot, each slot having an open end, hereinbelow alternatively or also referred to in brevity as an opening, and a closed end. A puller or tab, for example of a fastener, may be slid along the slot via the opening. Such puller may be locked within the slot by obstructing the opening with one or more arm members that are selectively moved into a locking obstructing position.

In some of the embodiments the lock mechanism has some resistance to forced opening when the mechanism is in lock state, e.g., when the puller is locked in the slot.

In some embodiments the lock mechanism can be opened by providing a user-specific means of identification that is recognized by the lock mechanism, which may remove the arm/s to another position allowing the puller to slide out of the slot.

Various embodiments include one or more features that may contribute to preventing forced and/or unauthorized opening of the lock mechanism.

Some item storage embodiments may each include a plurality of lock mechanisms, for example for a plurality of fasteners on an item storage embodiment. Each lock mechanism may include a plurality of similar or identical components, such as the arms, that may act independently or cooperatively with each other, according to the structure of the embodiment.

### BRIEF DESCRIPTION OF THE FIGURES

The figures illustrate generally, by way of example, but not by way of limitation, various embodiments discussed in the present document. For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

The number of elements shown in the Figures should by no means be construed as limiting and is for illustrative purposes only.

FIG. 1 is an example schematic partial view of an item storage system comprising a plurality of item storage devices, each item storage device comprising a lock mechanism and a fastener which includes a puller, according to one embodiment;

FIG. 2A is an example schematic view of a lock mechanism embodiment having two arms, the mechanism being in locked state;

FIG. 2B schematically illustrates the same lock mechanism embodiment as is shown in FIG. 2A, in the same view, in an unlocked state;

FIG. 2C schematically presents a side view of the lock mechanism depicted in FIGS. 2A and 2B;

FIG. 3A is an example schematic rear view of a lock mechanism of a yet other embodiment, wherein the lock mechanism has a single arm and the lock mechanism is shown in a locked state;

FIG. 3B schematically illustrates the same lock mechanism embodiment in the same view but in an unlocked state;

FIG. 3C schematically presents a side view of the mechanism depicted in FIGS. 3A and 3B;

FIG. 4 shows an example schematic front view of a front panel of the lock mechanism, according to some embodiments;

FIG. 5 presents a schematic side view of an item storage device with a large puller and a lock mechanism with a back panel, wherein the puller is inclined relative to a front panel and is pulled away from a closed end of a slot in the lock mechanism.

FIG. 6 presents the same schematic side view of the item storage device depicted in FIG. 5, wherein the puller is held perpendicular to the front panel;

FIG. 7A presents a schematic side view of an item storage device with a large puller and a lock mechanism with no back panel, according to some embodiments;

FIG. 7B shows the item storage device depicted in FIG. 7A, wherein the puller is illicitly moved out of the lock mechanism;

FIG. 8A shows an example schematic view of a lock mechanism embodiment with an cam or rotating member operationally coupled to locking arms and an actuator, wherein the cam or rotating member is ovaline, and is rotatable and further wherein the arm member is in a first position;

FIG. 8B depicts the lock mechanism embodiment shown in FIG. 8A, wherein the cam or rotating member is in a second position;

FIG. 9A schematically depicts a lock mechanism embodiment wherein the cam or rotating member is an obtuse rhomboid, and is rotatable and thereby switchable between the first and second positions; the cam or rotating member is in a first position;

FIG. 9B schematically depicts the lock mechanism embodiment shown in FIG. 9A, wherein the cam or rotating member is in a second position; and

FIG. 10 schematically depicts a lock mechanism embodiment wherein the cam or rotating member comprises a stem with round shoulders, and wherein the shoulders abut the frame when the cam or rotating member is in the first position as in the figure.

### DETAILED DESCRIPTION

The following description of item storage devices and lock mechanisms for item storage devices is given with reference to particular examples, with the understanding that such systems and methods are not limited to these examples.

According to some embodiments, an item storage device for securely storing items may comprise a container or receptacle such as, for example, a garment bag. In some embodiments, the terminology “securely storing” as well as grammatical variations thereof may relate to a configuration in which access to the receptacle's storage area is, by design-intent, not intended to be enabled other than through unsecuring of a fastener and setting the fastener to open the receptacle without damaging or otherwise compromising the structural and/or functional integrity of the receptacle.

The receptacle may define a storage area for receiving an item, e.g., at a hanger by suspension. A fastener (e.g., a zipper) may operably cooperate with a lock mechanism for selectively securing the fastener in a closed position and for unsecuring the fastener for allowing the fastener to be set from the closed into an open position. In the open position, the receptacle's storage area can be accessed by a user of the device for removing an item and/or placing an item therein for storage.

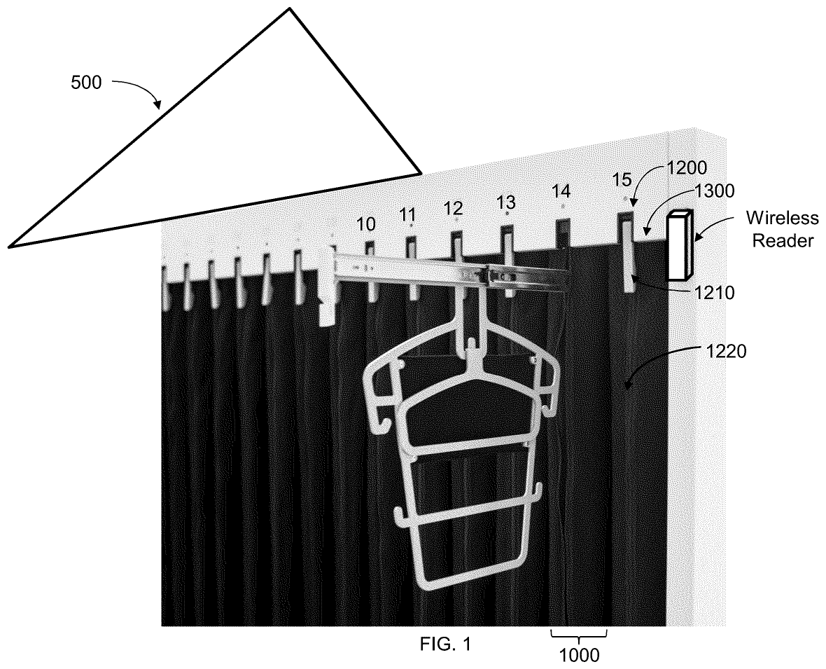

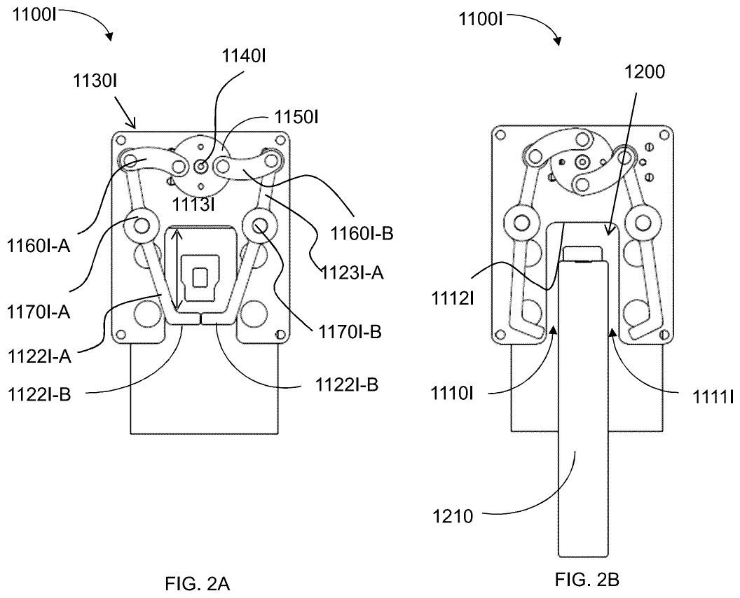

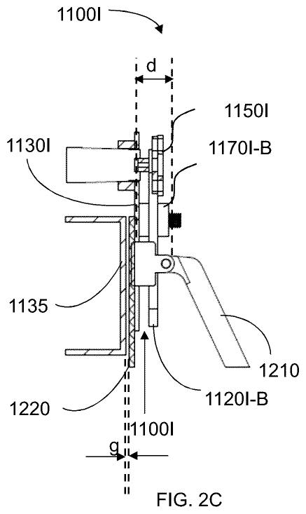

Reference is made to FIGS. 1, 2A and 2B. An item storage system (also: wardrobe system) 500 comprises a plurality of item storage devices 1000. Each item storage device 1000 may include a lock mechanism 1100 and a fastener 1200 which includes a puller 1210 and a zipper track 1220. Storage device 1000 comprises a body 1300 which can constitute the exterior bulk of the device 1000. The system may optionally comprise a wireless reader, which is schematically shown in FIG. 1.

FIG. 2A schematically illustrates a lock mechanism embodiment 11001 in locked state, and FIG. 2B schematically illustrates the same lock mechanism embodiment 11001 in an unlocked state. FIG. 2C schematically presents a side view of the mechanism illustrated in FIG. 2A.

Some storage device embodiments include a plurality of lock mechanisms/fasteners/pullers, for example each fastener may include a zipper and each zipper may be operationally coupled to two pullers, allowing opening the zipper in two opposite directions. Each puller may be immobilized by a lock mechanism.

One focus in the description below is on the lock mechanism 1100, which can be realized by various embodiments, some of which are described below. Some of the lock mechanism embodiments vary independently of the specific structure of the other components of the storage device; however, it will be apparent that the structures of some lock mechanism embodiments are interdependent of one or more of the components.

The lock mechanism 1100I includes a slot 1110I having an open end, for brevity referred hereinbelow as an opening 1111I, and a closed end 1112I. The lock mechanism 1100I further includes a pair of movable arms 1120I-A, 1120I-B. The device 1000I is configured to allow positioning the puller 1210I in the slot 1110I. The device 1000I is also configured to prevent moving the puller 1210 outside the slot 1110I holding the puller 1210I when the arms 1120I-A, 1120I-B obstruct the slot 1110I adjacent to the opening and the puller 1210 is situated between the arms 1120I-A, 1120I-B and the closed end 1112I. One aspect is that lock mechanisms 1100I for puller-equipped fasteners 1200 are provided.

Exemplified first in FIGS. 2A and 2B, such mechanism 1100I includes: a frame 1130I having a slot 1110I, the slot comprising an opening 1111I and a closed end 1112I; an actuator 1140I affixed to the frame 1130I; a plurality of arms (e.g., two arms 1120I-A, 1120I-B) that are operationally coupled with the actuator 1140I; a cam or rotating member 1150I operationally coupled to the actuator 1140I and to the arms 1120I-A, 1120I-B coupled thereto. Each arm 1120I-A, 1120I-B obstructs the slot 1110I adjacent to the opening 1111I, as illustrated in FIG. 2a, when the actuator 1140I coupled thereto is in a first state, and unblocks the slot 1110I, as shown in FIG. 2b, when the actuator 1140I coupled thereto is in a second state. The rotating member 1150I is selectively switchable by the actuator 1140I coupled thereto between a first position when the actuator 1140I is in the first state and a second position when the actuator 1140I is in the second state.

The lock mechanism 1100I is configured to allow rotating member 1150I in the first position to counterpoise force enacted on the two arms 1120I-A, 1120I-B coupled thereto to unblock the slot 1110I, and in the second position to allow the arms 1120I-A, 11201-B coupled thereto to unblock the slot 1110I.

Note that the actuator's different states are not distinguishable in the FIGS. 2a, 2b. However, change of position of the rotating member 1150I, as a result of being rotated, for example about 100° by the actuator 1140I, is apparent.

Additionally referring to FIG. 2C, the puller 1210 is pulled up into the slot 1110I when the lock mechanism 1200I is in open position illustrated in FIG. 2b. Once pulled to the top, upon activating the actuator 1140I, the member 1150I is rotated, forcing the arms 1120I-A, 1120I-B to close below the puller 1210. The puller 1210 is latched and cannot be pulled down. Illicit attempts to pick the lock mechanism 1100I might involve trying to force the arms 1120I-A, 1120I-B to unblock the slot 1110I. In some embodiments, the lock mechanism 1100I is self-locking, i.e., attempts to force the arms 1120I-A, 11201-B open may generate forces that act toward the axis centre of the rotating member 1150I, and preventing rotating member 1150I from rotating to unblock the slot.

In some embodiments the lock mechanism 1100I is further configured to prevent a force enacted on the arms 1120I-A, 1120I-B to sufficiently affect structural integrity of the rotating member 1150I and/or position of the rotating member 1150I to allow unblocking the slot 1110I. For example, the arms 1120I-A, 1120I-B may be made of a strong thermoplastic material, whereas or rotating member 1150I comprises steel, at least in the regions of the rotating member 1150I that are in contact with the arms 1120I-A, 1120I-B. Forcing the arms 1120I-A, 1120I-B might bend the arms but may leave the rotating member 1150I intact, so that the lock mechanism 1100I retains some functionality.

In some embodiments the actuator may comprise, for example, manually, electrically, or electromechanically mechanisms that are operable to selectively switch the rotating member between the first and second positions.

In some embodiments the arms 1120I-A, 1120I-B are movable by the actuator 1140I switching rotating member 1150I between the first position and the second position.

As shown in FIG. 2C, when the puller is positioned in the slot 1110, a distance between a rigid back panel 1135 and the zipper car (also: slider) 1230 of the puller 1210 is sufficiently small so that the zipper car 1230 cannot be pushed behind the arms 1120, even after (e.g., forcibly) decoupling of the puller 1210 from the zipper car 1230, preventing illicit opening of the bag. The rigid back panel 1135 may be fixedly coupled with a support structure or frame of item storage system 500.

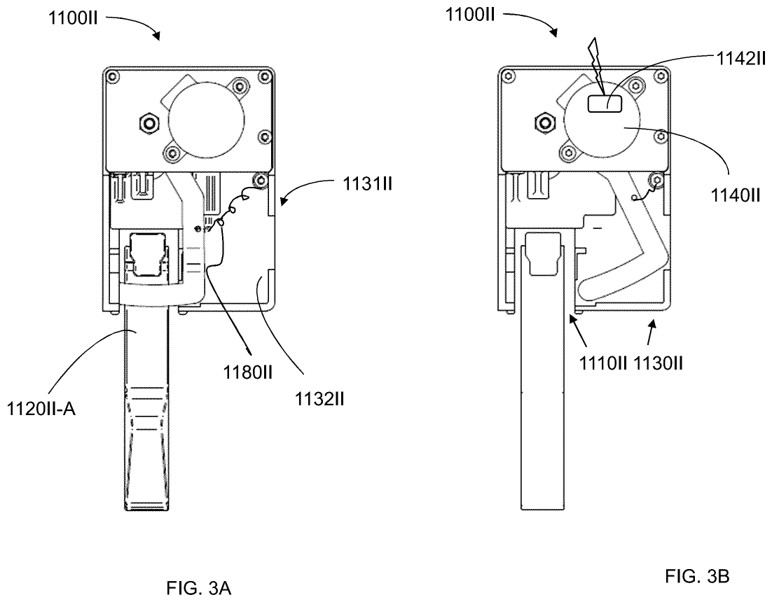

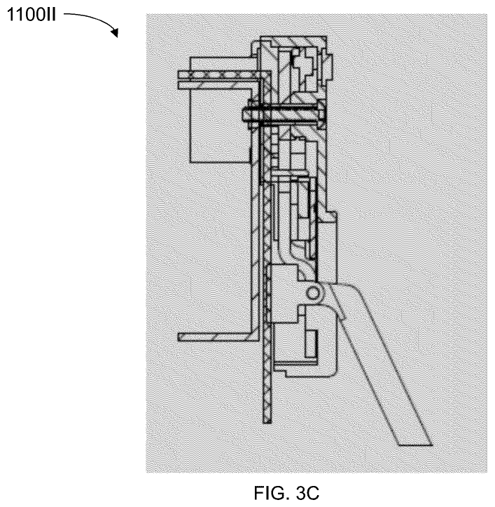

Additional reference is made to FIGS. 3A and 3B. FIG. 3A schematically depicts in rear view another embodiment 1100II in a locked state and FIG. 3B schematically illustrates the same lock mechanism embodiment 1100II in the same view but in an unlocked state. FIG. 3C is a side view of the lock mechanism 1100II of FIG. 3A in the locked state and FIG. 3D schematically presents a front view of the lock mechanism 1100II of FIG. 3A in the locked state. The lock mechanism 1100II has a single arm 1120II-A.

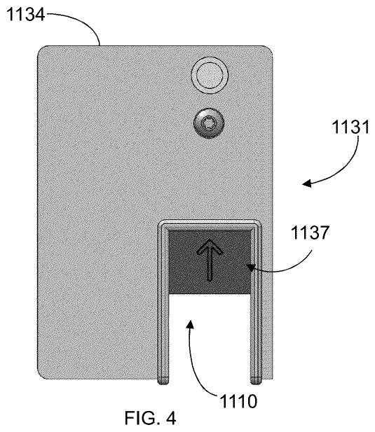

Further referring to FIG. 4, the frame 1130II comprises a front panel 1131II, the front panel 1131II comprising an exterior face 1134II, an interior face 1132II and the slot 1110II, wherein the rotating member (not shown in FIGS. 3A and 3B) and the actuator 1140II are situated distal to the slot 1110II, and proximal to the interior face 1132II. The positions of the rotating member and the actuator 1140II may provide protection from tampering.

It is apparent in viewing FIG. 4 that also a user will have limited or no direct physical access to the actuator to manipulate the lock mechanism 1100II. In some embodiments the actuator 1140II is remotely operable. For example, the actuator 1140II may include an RFID tag or reader 1142II, which can be an active or passive RFID reader. The lock mechanism 1100II may be further configured to allow the RFID tag/reader 1142II to transmit at least a first signal to the actuator 1140II when the RFID tag/reader 1142II receives a unique user-identifying signal, and the actuator 1140II to assume the second state when the actuator 1140II receives the first signal. The user-identifying signal may be received from a RFID-card or RFID emitter (not shown), for example.

Whereas the one armed lock mechanism embodiment 1100II may be simpler in structure than multi-arm lock mechanisms 1100I, the two-armed lock mechanism embodiment 1100II described, for example, in conjunction with FIGS. 2A and 2B may be comparatively more compact/space efficient solution than single-arm embodiments such as 1100II described above, due to the relatively short distance each arm, taken alone, of the two-armed lock embodiment, must traverse to block the slot 1110 compared to the distance the arm in the single-arm lock embodiment must traverse to block the slot.

Additional reference is made to FIG. 4. In some embodiments, the lock mechanism 1100 comprises a front panel 1134 including a slide panel 1137 that is slidably coupled to front panel 1134. Slide panel 1136 may be operably coupled with the actuator 1140. The actuator 1140 may operably engage the locking arm(s) to block the slot 1110 only after slide panel 1137 is slid open, e.g., by puller 1210, as shown in FIG. 4. This way, inadvertent or unintentional blocking of the slot 1100 by the locking arms without the puller 1120 being in the slot 1110 is prevented. Thus, receiving an indication that the device is in a locked state can be prevented, unless puller 1210 is engaged and pulled into slot 1110. Accordingly, providing a false-positive locking-state output may be prevented. In some examples, slide panel 1136 may be operable to physically block the path of the locking arm(s). In some further examples, slide panel 1136 may be electronically coupled with actuator through sensors (herein: panel sensors) that can detect the position of slide panel 1136 (open or closed) for unblocking or blocking the actuator, respectively. Slide panel 1136 can be considered “open” when pushed up by puller 1210.

In some embodiments, indication of an “open” panel 1136 does not suffice to enable actuation of actuator 1140, and detection of puller 1210 in the correct position within slot 1110 may be an additional or alternative requirement to allow the operable engagement of actuator 1140 to move the locking arm(s) in a locking position. The detection of the position of puller 1210 (within slot/pulled up or not within slot/pulled down) may be performed electronically by a “puller sensor” and/or mechanically.

In some embodiments, the position of the locking arms 1120 (blocking/closed or not blocking/open) may be detectable by sensors (herein: locking arm position sensors). Output light (e.g., LEDs) may provide outputs indicative of the locking arm (open or closed) positions. For example, a green LED output may be indicative of the locking arms being in “open” positions, and a red LED output may be indicative of the locking arms being in “closed” position. These outputs can be provide an indication that the path traversed by the locking arm(s) when the arms were operably engaged by the actuator to move to the “closed” position was not obstructed. The output provided by the “locking arms position sensors” may be cross-referenced against signal descriptive of a command to lock the lock mechanism. A discrepancy between the output by the locking arms positions sensors indicating that the arms are in “open” position and the signal command to lock the lock mechanism can provide an indication of illicit attempts to forcefully retract the locking arms from their “closed” position into the “open” position. An alarm may be triggered in response to detecting such attempt.

Sensors such as panel sensors, locking arm sensors, and puller sensors may be implemented, for example, by position and/or proximity sensors. The configuration shown in FIG. 4 may be employable for all embodiments discussed herein, e.g., for any single-or two-arm lock embodiments.

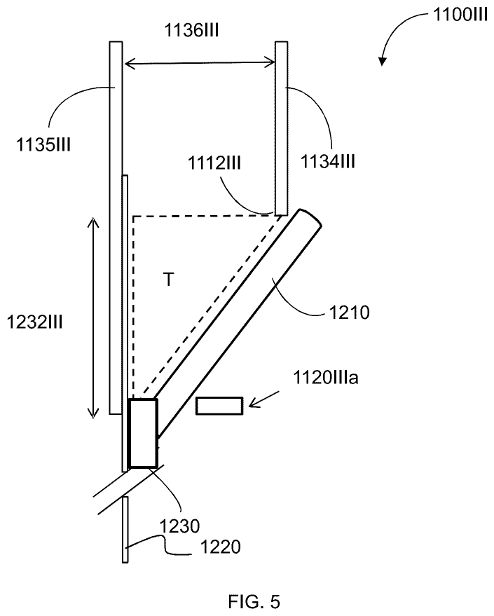

Additional reference is made to FIGS. 5, 6 and 7A-7B, illustrating a schematic side view of item storage device 1000III, similar to the viewpoints of side views 2C and 3D (in FIG. 5 the puller 1210 is swivelled to be pointing upwards rather than downwards in FIGS. 2C and 3D). Equipping the device with a large size of puller 1210 relative to the distance 1136III between the front panel 1134III and the back panel 1135III more securely restricts the puller 1210 than a small size of puller 1210. Similarly, as shown in FIG. 2A, the size of the puller 1210 may be selected to be large relative to a distance 1113I between the arm 1120Ia at a position obstructing the slot 1110I, and the closed end 1112I of the slot. For example, the zipper car 1230 may have a shape (e.g., depth d) that is larger than the gap between the back wall 1135 and the locking arm 1120, therefore regardless of the puller and the front panel, the zipper car 1230 cannot be pushed behind the locking arms, preventing the zipper car 1230 from being pull down, unless the locking arms are retracted to the open position. In some embodiments, when the zipper car 1230 is pulled up above the height of the locking arm(s) 1120, there may be no gap or only a negligible small gap (g) of, e.g., a few millimetres, for example, between the posterior surface of the zipper car 1230 and the anterior surface of the back wall 1135. The terms “anterior” and “posterior” as used herein are relative terms and herein used with respect to a front view of the item storage system 500.

In particular, an illicit attempt might be made to get the puller 1210 out of the lock mechanism 1100III, without moving the arm 1120IIIa from the lock position. Such attempt may involve two steps: 1) inclining the puller 1210 2) pulling the puller 1210 away from the closed end 1112III of the slot 1110III, in order to get the puller 1210 under the front panel 1234III. Once the puller 1210 is under the front panel 1234III the puller 1210 might subsequently be laid flat and pulled entirely away from the lock mechanism 1100III. The puller 1210 is blocked by the arm 1120IIIa from being further pulled away and is blocked by the front panel 1234III from being further inclined.

When pulled and inclined to the furthest extent, the puller 1210, if adequately long, touches the arm 1120III and the front panel 1234III. At this position a straight triangle T may be defined by the puller 1210, arm 1120IIIa and the closed end 1112III. Note that an attempt to illicitly open the item storage fastener may also include a step of 3) pushing the puller 1210 away from the front panel 1234III, in order to allow more inclining of the puller 1210. Such step may be effectively blocked by the back panel 1135III.

In some item storage embodiments the fastener 1200 comprises two rows of teeth (not shown) forming a zipper track 1220, and a zipper car 1230 operably coupling the puller 1210 with the zipper track 1220.

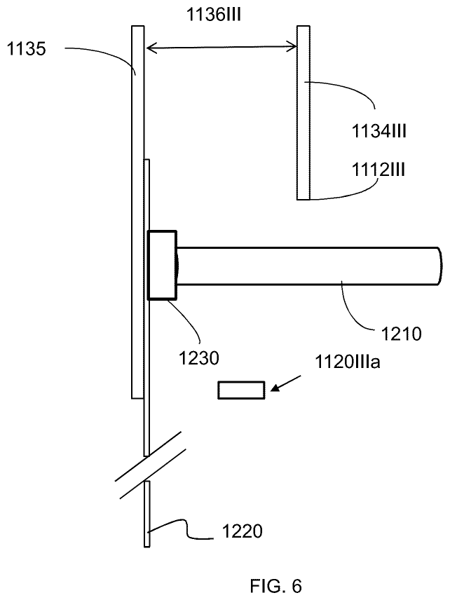

The puller 1210 and zipper car 1230 coupled thereto together extend to a first distance 1212III from the zipper track 1220 when the puller 1210 is held vertical to the zipper track 1220 as schematically illustrated in FIG. 6.

The closed end 1112III of the slot 1110III is positioned a second distance 1136III from the back panel 1135III. The zipper car 1230 is distanced a third distance 1232III from the closed end 1112III of the slot 1110III when the arm 1120IIIa is in closed position, and the puller 1120 is inclined relative to the front panel 1134III and in contact with the arm 1120IIIa. At such position of the puller 1210 a triangle may be formed like T, with vertices first distance 1212, second distance 1136III and third distance 1232III.

According to Pythagoras theorem, the puller 1210 may be have adequate length to prevent illicitly pulling out the puller 1210 as described above, when the squared first distance 1212III is substantially larger than the sum of the squared second distance 1136III and the squared third distance 1232III.

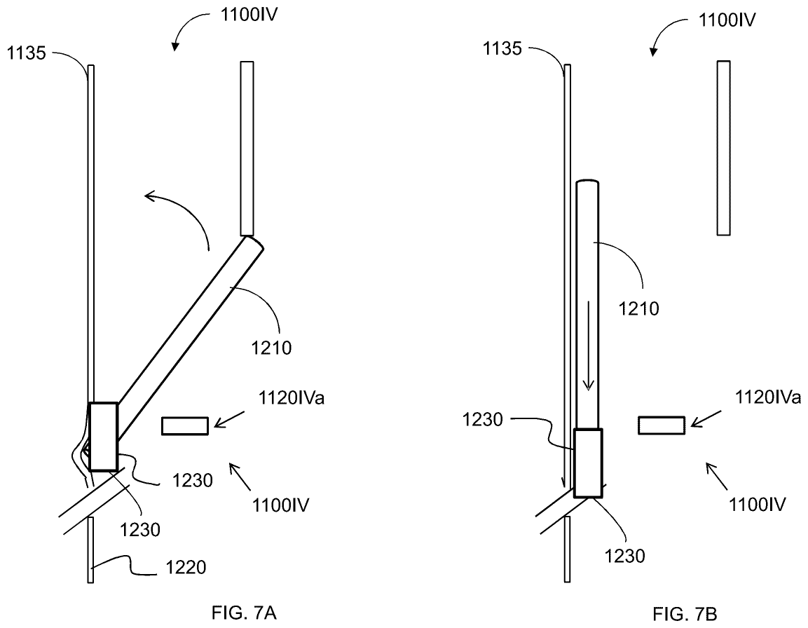

FIG. 7A shows a schematic side view of item storage device 1000IV, similar to the viewpoints of the side views FIG. 5 and FIG. 6. However, in contrast to the item storage device 1000III depicted in FIG. 5 and FIG. 6, this device 1000IV does not comprise a back panel. Therefore, pushing the puller 1210 causes the zipper track 1220 and/or surrounding body to sink or tear sufficiently to allow the puller 1210 to be brought under the arm 1120IVa and out of the lock mechanism 1100IV, as shown in FIG. 7b.

In some embodiments, and as already described herein, zipper car 1230 may be shaped such as to help prevent pulling the zipper car 1230 under the locking arm(s) 1120 when the arms are in the closed/blocking position, even after the puller 1210 is (e.g., forcibly) removed from the zipper car 1230.

In some embodiments, after removal of the puller 1210, the zipper car 1230 can be pulled under the locking arm/s 1120a, 1120b, even if the locking arms are in the closed/blocking position. However, the puller 1210 may be shaped (e.g., curved), such that as long as the puller 1210 is operably coupled with the zipper car 1230, the puller 1210 cannot be pulled under locking arm(s) so as to help prevent pulling the puller 1210 under the locking arm/s 1120a, 1120b when the arms are in the closed/blocking position.

In some embodiments, the back panel is 1135 fixedly coupled with the frame of the wardrobe system 500 (e.g., with rivets, welding, integrally formed). Optionally, the back panel is affixed to the body of the device, for example, by heat fusion/welding of a thermoplastic back panel and a thermoplastic body, or by any other technique. In some embodiments the back panel is affixed to the body with mechanical fasteners such as rivets. In some embodiments such as the locking device 1100III depicted in FIG. 5 the back panel is situated inside the receptacle, i.e., inside the body. In some other embodiments such as the device 1000 shown in FIG. 1 the back panel 1135 is affixed onto the body 1300. In some embodiments the back panel is flush with the body. In yet other embodiments the device does not comprise a back panel. In such devices the body itself may nevertheless provide some help in preventing pushing the puller under the arm/s in their lock positions, especially if the body comprises rigid material. In some embodiments, the rotating member has a geometry that plays a part in the locking and unlocking.

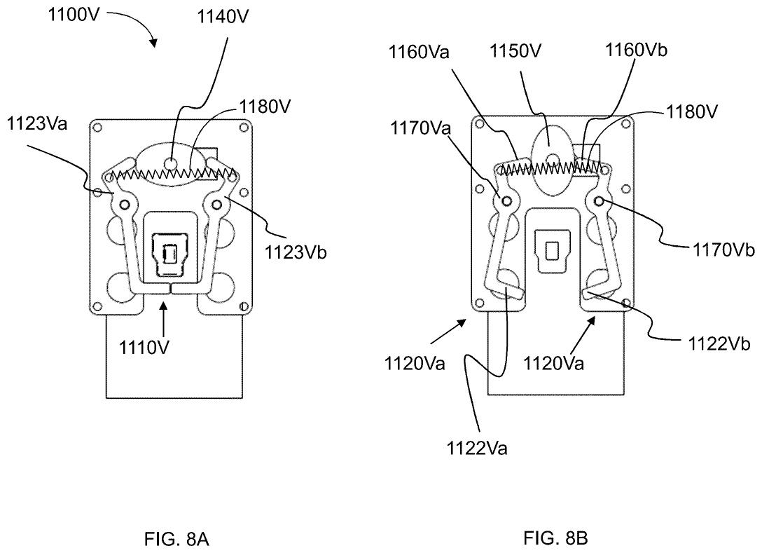

FIGS. 8A and 8B, schematically depict a lock mechanism embodiment 1100V, including a rotating member 1150V operationally coupled to locking arms 1120V-A, 1120V-B, and actuator 1140V, wherein the rotating member 1150V is ovaline, and is rotatable and thereby switchable between the first (FIG. 8A) and second (FIG. 8B) positions.

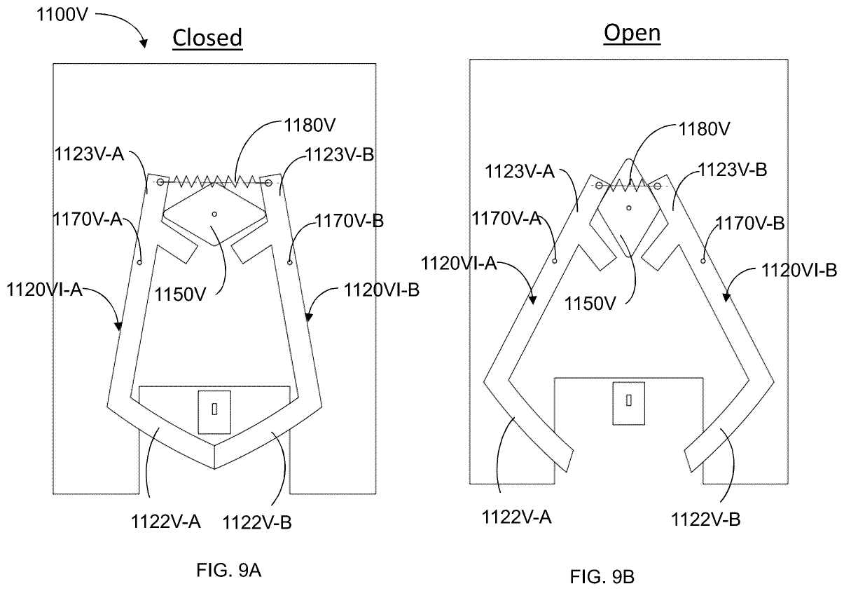

FIGS. 9A and 9B schematically depicts a lock mechanism embodiment 1100VI wherein the rotating member 1150VI is a rhomboid, and is rotatable and thereby switchable between the first (FIG. 9A) and second (FIG. 9B) positions.

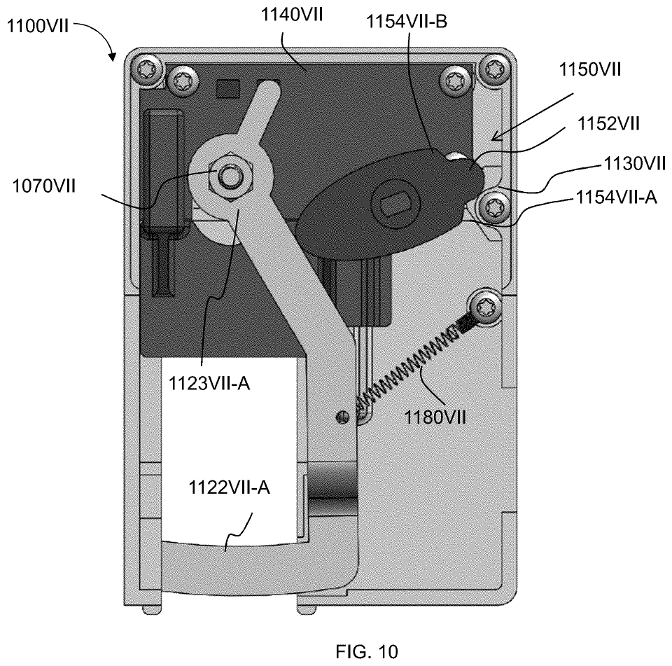

FIG. 10 schematically depicts a lock mechanism embodiment 1100VII wherein the rotating member 1150VII comprises a stem 1152VII which may comprise at least one round shoulders 1154VII, 1154VII. The shoulder 1154VII-A abuts against the frame 1130VI when the rotating member 1150VII is in the first position as in the figure. The frame 1130VII engaging with the shoulder serves as a strong support for the rotating member 1150VII, to help secure the lock mechanism 1100VII from forced illicit opening.

Some lock mechanism embodiments further comprise arm fulcrums. For example, referring to FIGS. 2A, 8A and 9A, lock mechanisms 1100I, 1100V, 1000VII described above, without a fulcrum for each arm 1120I-A, 1120I-B 1120V-A, 1120V-B, 1120VII-A, 1120VII-B, the arm 1120I-A, 1120I-B, 1120V-A, 1120V-B, 1120VII-A, 1120VII-B can be easily moved to open the slot 1110I, 1110V, 1110VII. The arm fulcrums 1170I-A, 1170I-B, 1170V-A, 1170V-B, 1170VII-A, 1170VII-B provide support to the arms 1120I-A, 1120I-B, 1120V-A, 1120V-B, 1120VI-A, 1120VI-B respectively to resist opening the arms 1120I-A, 1120I-B, 1120V-A, 1120V-B, 1120VII-A, 1120VII-B when the 1110I, 1110V, 1110-VII is obstructed.

Each arm fulcrum 1170I-A, 1170I-B, 1170V-A, 1170V-B, 1170VII-A, 1170VII-B is respectively situated between a free first end 1122I-A, 1122I-B, 1122V-A, 1122V-B, 1122VII-A, 1122VII-B and a second end 1123I-A, 1123I-B, 1123V-A, 1123V-B, 1123VII-A, 1123VII-B. The arms 1120I-A, 1120I-B, 1120V-A, 1120V-B, 1120VII-A, 1120VII-B respectively rotate on the arm fulcrums 1170I-A, 1170I-B, 1170V-A, 1170V-B, 1170VII-A, 1170VII-B.

Some lock embodiments with arms hinged on fulcrums further include joints. Referring to FIGS. 2A and 2B, the joint 1160I-A, 1160I-B is engaged with the rotating member 1150I. Each arm 1120I-A, 1120I-B has the second end 1122I-A, 1122I-B rotatably engaged with the joint 1160I-A, 1160I-B. The engagement is such that the first ends 1122I-A, 1122I-B, 1122V-A, 1122V-B, obstruct the slot 1110I, 1110V respectively, when the rotating member 1150I, 1150V pushes the joints 1160I-A, 1160I-B, 1160V-A, 1160V-B.

In some alternative lock mechanism embodiments such as the lock mechanism 1100VI illustrated in FIG. 10, arm 1120VIa has a free first end 1122VI-A and a second end 1123V rotatably engaged with a fulcrum 1170VI, wherein the rotating member 1150VI is coupled to the arm 1120VI-A between the first free end 1122VI-A and the second end 1123VI-A.

In some lock mechanism embodiments each actuator comprises at least one rotating member. Change of state of the actuator typically always leads to a change in position of the rotating member; therefore, typically the rotating member can be considered as a part of the actuator, i.e., the part of the actuator that is in contact with the arm/s. Alternatively, some actuators may be considered to be part of a rotating member, or to be the rotating member.

Some lock mechanism embodiments further comprise mechanical energy storage device (e.g., a resilient component), which may be engaged with the frame and with at least one arm, or with at least two arms, for example, for pulling the at least one arm to unblock the slot. In some other embodiments, the lock mechanism may be configured such that the mechanical energy storage device pushes the at least one arm to block the slot. The mechanical energy storage device may comprise a spring, a pneumatic mechanism, a hydraulic mechanism, an elastic band, and/or the like.

See for example embodiments 1100II, 1100III, 1100VII in FIGS. 3A, 3B, and 10 schematically showing a resilient component. The resilient component 1180II, 1180III, 1180VII is engaged with the frame 1130II, 1130III, 1130VII, and with the arm 1120II, 1120III, 1120VII, respectively. In the embodiment 1100VI depicted in FIG. 9A, the resilient component 1180VI is engaged with the arms 1120VIa and 1120VI-B, respectively. The resilient component 1180VI is stretched when the at least one rotating member 1150VI is at the first position and is relaxed when the at least one rotating member 1150VI is at the second position.

In some embodiments 1100IV, 1100VI in which the resilient component 1180VI is engaged with two arms 1120VI-A and 1120VI-B, the rotating member 1150VI is situated in between the two arms 1120VI-A and 1120VI-B, respectively. The resilient component 1180VI is stretched when rotating member 1150VI is at the first position shown in FIG. 9A, and is relaxed when the at least one rotating member 1150VI is at the second position shown in FIG. 9b.

In some device embodiments (not shown) an alarm system may be operably coupled with the receptacle and/or fastener and/or lock mechanism such as to provide an alarm output responsive to detecting an attempt to forcefully gain access to the receptacles' storage area, e.g., responsive to detecting that the structural integrity of the receptacle and/or fastener and/or lock mechanism is compromised.

According to some embodiments (not shown), the receptacle may comprise one or more conductive pathways running along the body of the receptacle and/or fastener and/or lock mechanism, e.g., to form a mesh like pattern matching or substantially matching the geometric structure of the receptacle's body/fastener/lock mechanism. The conductive pathways may be independently for each of body/fastener/lock mechanism operably comprised in an alarm system which provides an output in the event the structural integrity of one or more of the conductive pathways is compromised or damaged, e.g., due to an attempt to forcefully gain access to the receptacle's storage area rather than through authorized unsecuring of the lock mechanism and setting of the fastener from the closed in the open position. Such attempts may include, for example, rupturing and/or slicing of the receptacle; and/or breaking of the lock mechanism. According to some embodiments, portions of the conductive pathways may run and extend at least partially below two rows of teeth of a zipper which may embody the fastener.

Any of the lock mechanisms 1100I, 1100II, 1100III, 1100V, 1100V, 1100VI, 1100VII may for example be embodied by a mechanical system (e.g., manual and/or electrically driven), by an electronic or electrical system (e.g., electromagnetically operated and/or code-based keypad input) or by a hybrid, electro-mechanical lock mechanism. For example, entirely manually operated (e.g., by a manually operable cylinder lock) or comprise an electromechanical drive that is operated responsive to receiving an input (e.g., via a keypad or by inserting a key into hybrid electromechanical cylinder lock). An electromechanical lock mechanism may be for example solenoid-based and/or a servo-based linear or rotary actuator. For example, keypad-operated (e.g., operative to receive a code for authentication) and/or key-cylinder operated for selectively locking and unlocking. Optionally, unlocking and locking may be activated responsive to providing a biometric input, if authenticated.

Additional or alternative technologies that may be employed for selective locking and unlocking of lock mechanism 1100I, 1100II, 1100III, 1100V, 1100V, 1100VI, 1100VII responsive to received and authenticated user identification information may include, for example, RFID; a machine-readable labels encoding information (e.g., a barcode, a matrix barcode); near-field communication (NFC); magnetic strip card; a mobile application of a mobile computerized end-user device (not shown) for communication with lock mechanism 1100I, 1100II, 1100III, 1100V, 1100V, 1100VI, 1100VII (e.g., by employing bluetooth™, Zigbee™ or any other wireless communication protocol or standard) for the remote and selective locking and unlocking of the lock mechanism 1100I, 1100II, 1100III, 1100V, 1100V, 1100VI, 1100VII, e.g., through a barcode, passcode, biometric input and/or the like provided from and/or via the mobile computerized end-user device; and/or one-wire technology.

Optionally, an RFID chip encoding authentication information may be embedded into, e.g., an injection moulded component. In some embodiments, a chip encoding unique user identification (ID) information may communicate with a processor or controller of lock mechanism 1100I, 1100II, 1100III, 1100V, 1100V, 1100VI, 1100VII through 1-wire and/or any other MicroLan technology.

For example, a first communication interface (not shown) of such MicroLan technology may be operably placed into a keyhole (or in any other user-accessibly arrangement) of lock mechanism 1100I, 1100II, 1100III, 1100V, 1100V, 1100VI, 1100VII. A second communication interface (not shown) operable to communicate with the first communication interface may be part of a button, key or any other user-component.

The second communication interface may for example be comprised in an injection-moulded key-shaped user component. If the second interface of such one-wire-based (e.g., key-shaped) user component is operably coupled by the user of the storage system with the first communication interface of the lock mechanism 1100I, 1100II, 1100III, 1100V, 1100V, 1100VI, 1100VII and the ID information encoded in the chip of the user component is authenticated, lock mechanism 1100I, 1100II, 1100III, 1100V, 1100V, 1100VI, 1100VII may be set, depending on the initial configuration, from the locked into the unlocked configuration, or from the unlocked to the locked configuration, e.g., through activation of an electromechanical mechanism, or by unblocking a rotation mechanism for allowing the turning of the key-shaped user component for the locking or unlocking of lock mechanism 1100I, 1100II, 1100III, 1100V, 1100V, 1100VI, 1100VII.

### ADDITIONAL EXAMPLES

Example 1 comprises a lock mechanism for at least one puller-equipped fastener, the lock mechanism comprising: a frame having at least one slot, each of the at least one slot comprising an opening and a closed end; at least one actuator affixed to the frame; at least one arm operationally coupled to each actuator, and at least one rotating member operationally coupled to each actuator and to the at least one arm coupled thereto; wherein each arm obstructs one of the at least one slot adjacent to the opening when the actuator coupled thereto is in a first state, and unblocks the slot when the actuator coupled thereto is in a second state, and wherein each at least one rotating member is selectively switchable by the actuator coupled thereto between a first position when the actuator is in the first state and a second position when the actuator is in the second state, and wherein the lock mechanism is configured to allow each at least one rotating member in the first position to counterpoise force enacted on the at least one arm coupled thereto to unblock the slot, and in the second position to allow each at least one arm coupled thereto to unblock the slot.

Example 2 includes the subject matter of example 1 and, optionally, wherein the lock mechanism is further configured to prevent force/s enacted on the at least one arm to sufficiently affect structural integrity of the at least one rotating member, and/or to affect positions of the at least one rotating member, such as to allow unblocking the slot.

Example 3 includes the subject matter of example 1 or example 2 and, optionally, wherein the actuator is selected from a group consisting of: manually, electrically, or electromechanically operable to selectively switch the rotating member between the first and second states.

Example 4 includes the subject matter of any one of the examples 1 to 3 and, optionally, wherein the frame comprises a front panel, the front panel comprising an exterior face, an interior face and the slot, wherein the at least one rotating member and the actuator are situated distal to the slot, and proximal to the interior face.

Example 5 includes the subject matter of example 4 and, optionally, wherein the actuator is remotely operable.

Example 6 includes the subject matter of any one of the example 1 to 5 and, optionally, wherein the actuator comprises an RFID tag/reader, and wherein the lock mechanism is further configured to allow the RFID tag to transmit at least a first signal to the actuator when the RFID tag receives a unique user-signal, and the actuator to assume the second state when the actuator receives the first signal.

Example 7 includes the subject matter of any one of the examples 1 to 6 and, optionally, wherein the frame further comprises a back panel, wherein the at least one arm, at least one rotating member and actuator are situated in between the front panel and the back panel.

Example 8 includes the subject matter of any one of the examples 1 to 7 and, optionally, wherein the at least one arm is movable by the actuator switching the at least one rotating member between the first position and the second position.

Example 9 includes the subject matter of example 8 and, optionally, wherein the at least one rotating member is each independently an obtuse rhomboid or is ovaline, and wherein the at least one rotating member is each rotatable and thereby switchable between the first and second positions.

Example 10 includes the subject matter of example 9 and, optionally, wherein each at least one rotating member comprises a stem with round shoulders, and wherein the shoulders abut against the frame when the rotating member is in the first position.

Example 11 includes the subject matter of any one of the examples 1 to 10 and, optionally, further comprises at least one arm fulcrum, wherein at least one arm has a free first end and a second end, and each of the at least one arm fulcrum is situated between the free first end and the second end of the at least one arm, such that the at least one arm is rotatable on the arm fulcrum and resists opening an at least one obstructed slot.

Example 12 includes the subject matter of example 11 and, optionally, further comprises at least one joint, wherein each of the at least one joint is engaged with one of the at least one rotating member, and wherein at least one arm has the second end of the at least one arm rotatably engaged with the joint.

Example 13 includes the subject matter of any one of the examples 1 to 11 and, optionally, further comprises at least one arm fulcrum, wherein at least one arm has a first free end and a second end, and each of the at least one arm fulcrum is situated at the second end, and each at least one rotating member is coupled to one of the at least one arm between the first free end and the second end, such that the at least one arm is rotatable on the arm fulcrum and resists opening an at least one obstructed slot.

Example 14 includes the subject matter of any one of the examples 1 to 13 and, optionally, wherein each at least one actuator comprises one of the at least one rotating member.

Example 15 includes the subject matter of example 14 and, optionally, wherein each at least one actuator is one of the at least one rotating member.

Example 16 includes the subject matter of any one of the examples 1 to 15 and, optionally, further comprises a resilient component engaged with the frame and one of the at least one arm, wherein the resilient component is stretched when the at least one rotating member is at the first position and is relaxed when the at least one rotating member is at the second position.

Example 17 includes the subject matter of any one of the examples 1 to 15 and, optionally, further comprises a resilient component engaging two of the at least one arm, wherein one of the at least one rotating member is situated in between the two of the at least one arm, and wherein the resilient component is stretched when the at least one rotating member is at the first position and is relaxed when the at least one rotating member is at the second position.

Example 18 includes an item storage device comprising: the lock mechanism of any one of the example 1 to 17 and, optionally, a fastener comprising: at least one puller, wherein the frame further comprises a back panel, wherein the at least one arm, at least one rotating member and actuator are situated in between the front panel and the back panel, and wherein the device is configured to allow positioning each puller in one of the at least one slot, and to prevent moving the puller outside one of the at least one slot holding the puller when at least one arm obstructs the one slot adjacent to the opening, and the puller is situated between the at least one arm and the closed end of the slot.

Example 19 includes the subject matter of example 18 and, optionally, wherein the fastener further comprising two rows of teeth forming a zipper track, and a zipper car operably coupling at least one puller with the zipper track, wherein: one of the at least one puller and zipper car coupled thereto together extend to a first distance from the zipper track when the puller is held vertical to the zipper track; the closed end of the slot is positioned a second distance from the back panel, and when the at least one arm is in closed position, and the puller is inclined relative to the front panel and in contact with the arm, the zipper car is distanced a third distance from the closed end of the one slot, and wherein a first distance squared is larger than a sum of a second distance squared and a third distance squared.

Generally, authentication for verifying eligibility of a user to access (e.g., via biometric, key and/or code-based identification) an item storage device may be performed, for example, by an alarm module.

Generally, a mechanical system may also include pneumatic or hydraulic system.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

It should be noted that the term “item” as used herein refers to any physically tangible, individually distinguishable unit of packaged or unpackaged good or goods. Positional terms such as “upper”, “lower” “right”, “left”, “bottom”, “below”, “lowered”, “low”, “top”, “above”, “elevated”, “high”, “vertical” and “horizontal” as well as grammatical variations thereof as may be used herein do not necessarily indicate that, for example, a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

“Coupled with” means indirectly or directly “coupled with”.

It is important to note that the methods described above are not limited to the corresponding descriptions. For example, the method may include additional or even fewer processes or operations in comparison to what is described herein and/or the accompanying figures. In addition, embodiments of the method are not necessarily limited to the chronological order as illustrated and described herein.

It should be understood that where the claims or specification refer to “a” or “an” element or feature, such reference is not to be construed as there being only one of that element. Hence, reference to “an element” or “at least one element” for instance, may also encompass “one or more elements”.

Unless otherwise stated, the use of the expression “and/or” between the last two members of a list of options for selection indicates that a selection of one or more of the listed options is appropriate and may be made.

It is noted that the term “perspective view” as used herein may also refer to an “isometric view” and vice versa.

It should be appreciated that certain features which are, for clarity, described in the context of separate embodiments, may also be provided in combination in a single embodiment. Conversely, various features, which are, for brevity, described in the context of a single embodiment, example and/or option, may also be provided separately or in any suitable sub-combination or as suitable in any other described embodiment. Certain features described in the context of various embodiments are not to be considered essential features of those embodiments, unless the embodiment, example, and/or option are inoperative without those elements. Accordingly, features, structures, characteristics, stages, methods, modules, elements, entities or systems disclosed herein, which are, for clarity, described in the context of separate examples, may also be provided in combination in a single example. Conversely, various features, structures, characteristics, stages, methods, modules, elements, entities or systems disclosed herein, which are, for brevity, described in the context of a single example, may also be provided separately or in any suitable sub-combination.

It is noted that the term “exemplary” is used herein to refer to examples of embodiments and/or implementations, and is not meant to necessarily convey a more-desirable use-case.

In alternative and/or other embodiments, additional, fewer, and/or different elements may be used.

Throughout this description, various embodiments may be presented in a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include—where applicable—any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

While the aspects have been described with respect to a limited number of embodiments, these should not be construed as scope limitations, but rather as exemplifications of some of the embodiments.

What is claimed is:

1. A lock mechanism for at least one puller-equipped fastener comprising a zipper car, the lock mechanism comprising:
a frame having a slot comprising an open end and a closed end and configured for receiving a zipper car between the open and the closed end of the slot;
at least one arm for selectively obstructing and unblocking the slot;
at least one actuator; and
at least one rotating member that is operationally coupled with the at least one actuator and with the at least one arm,
wherein the at least one rotating member is selectively switchable by the at least one actuator between a first position when the actuator is in the first state for obstructing the slot and a second position when the actuator is in the second state for unblocking the slot,
wherein the at least one rotating member comprises a stem with round shoulders, and
wherein the shoulders abut against the frame when the rotating member is in the first position.

2. The lock mechanism of claim 1, wherein the lock mechanism is configured to allow the at least one rotating member in the first position to counterpoise force enacted on the at least one arm coupled thereto to obstruct the slot, and in the second position to allow each at least one arm coupled thereto to unblock the slot.

3. The lock mechanism of claim 1, wherein the actuator is selected from a group consisting of: manually, electrically, or electromechanically operable to selectively switch the rotating member between the first and second states.

4. The lock mechanism of claim 1, wherein the frame comprises a front panel, the front panel comprising an exterior face, an interior face and the slot, wherein the at least one rotating member and the actuator are situated distal to the slot, and proximal to the interior face.

5. The lock mechanism of claim 1, wherein the at least one arm is movable by the actuator switching the at least one rotating member between the first position and the second position.

6. The lock mechanism of claim 1, wherein the at least one rotating member is each independently an obtuse rhomboid or is ovaline, and wherein the at least one rotating member is each rotatable and thereby switchable between the first and second positions.

7. The lock mechanism of claim 1, further comprising at least one joint, wherein each of the at least one joint is engaged with one of the at least one rotating member, and wherein at least one arm has the second end of the at least one arm rotatably engaged with the joint.

8. The lock mechanism of claim 1, further comprising at least one arm fulcrum, wherein at least one arm supported by the at least one fulcrum has a first free end and a second end, each of the at least one arm fulcrum is situated at the second end, wherein each at least one rotating member is coupled to one of the at least one arm between the first free end and the second end, and wherein rotation of the rotating member causes the first free end to slide on the rotating member allowing selectively blocking and unblocking of the slot.

9. The lock mechanism of claim 1, further comprising a resilient component engaged with the frame and one of the at least one arms, wherein the resilient component is stretched when the at least one rotating member is at the first position and is relaxed when the at least one rotating member is at the second position.

10. The lock mechanism of claim 8, wherein the at least one arm includes a pair of arms.
